(19) United States
(12) Patent Application Publication
(10) Pub. No.: US 2009/0272040 A1
(43) Pub. Date: Nov. 5, 2009

(54) COMBINED MECHANISM OF ROLLER and SHAFT

(75) Inventor: Po-Feng CHEN, Taipei (TW)

Correspondence Address: SCHMEISER OLSEN & WATTS, 18 E UNIVERSITY DRIVE, SUITE # 101, MESA, AZ, 85201, US

(73) Assignee: PRO-HAWK CORPORATION, Taipei County (TW)

(21) Appl. No.: 12/114,971

(22) Filed: May 5, 2008

(51) Int. Cl. E05D 15/22; E05D 15/24

(52) U.S. Cl. 49/420; 160/210

(57) ABSTRACT

The combined mechanism of roller and shaft has a roller provided with dust and moisture proof means at both surfaces thereof that contribute to smooth operation of the mechanism for prolonged lifespan. The hollow structure of the shaft results in saving the material and fabrication costs. The shaft is successfully divided into a pivot section and an axle section with the aid of dexterously designed collar ringing the shaft at its front end and a ferrule holding the roller which is hinged to the riveted tip of the pivot section. The collar and the ferrule make the mechanism universally applicable to sectionalized lift up door for various applications, such as garage or vehicle door without the need of preparing different sized shafts to meet individual specifications.

### BACKGROUND OF THE INVENTION

1. Field of the Invention

The present invention relates to a combined mechanism of roller and shaft, and more particularly, a combined mechanism of roller and shaft in which a hollowed shaft and a dust and moisture proof roller are used to curtail the fabrication costs.

2. Description of the Prior Art

A combined mechanism of roller and shaft is a simplest machine yet it is widely applied to a garage or vehicle's lift-up door, a workshop conveyer or the like. Take a garage lift-up door for example, a combined mechanism of roller and shaft is installed symmetrically on the garage door and allows garage door panels to move up and stored during opening.

It has been an annoying experience that most conventional garage lift-up doors allow intrusion of dust, foreign materials and moisture into the roller bearings after long term use. As a result, the accumulation of dust or the like obstructs the smooth operation of the mechanism. In addition, conventional shafts are made of solid metal. Conventional shafts will greatly increase the fabrication costs as the inflation of metal price is getting worse and worse. Moreover, customized specifications of the mechanism to meet the requirements of individual clients further aggravates the costs of fabrication as a new mold has to be prepared each time for a particular order.

An improvement is seriously needed for the noticeable defects in the prior art.

The inventor has dedicated great efforts for years on studying and improving these defects and developed a novel combined mechanism of a roller and rotating shaft as provided in this invention to eliminate the defects mentioned above.

### SUMMARY OF THE INVENTION

Accordingly, an aspect of the present invention is to provide a combined mechanism of a roller and shaft in which a sealing function for dust and moisture are provided respectively at the front and rear sides of the roller so as to enable the mechanism to operate smoothly during its prolonged lifespan.

Another aspect of the present invention is to provide a combined mechanism of a roller and shaft in which the shaft is made hollow so as to save the consumption of the metallic material thereby curtailing the fabrication cost.

One additional aspect of the present invention is to provide a combined mechanism of a roller and shaft in which different sized ferrules can be installed at the front portion of the shaft so as to be adaptable to various specifications without the need of individually customizing a new mold for each particular manufacturer's requirements.

To achieve these and other aspects mentioned above, the mechanism of the present invention comprises a roller with a dust cap and a dust washer, and a shaft with a collar and a ferrule. The dust cap is to be covered on an annular detent groove formed around the front surface of the roller, while a dust washer is used to seal an annular slot formed around the rear surface of the roller so as to avoid intrusion of dust, moisture, foreign materials or the like into the roller bearing which is provided at the center portion of the roller to support the shaft. The shaft is made hollow and ringed with a collar at a proper position near its front end. The shaft is divided into a pivot section and an axle section. The ferrule, which is adapted to the pivot section, is fixed by the collar. The ferrule can be manufactured to a variety of sizes to accommodate different requirements. The pivot section of the shaft passes through the center of the roller and rests on the bearing. The roller is held by the ferrule. Finally the roller is hinged to the riveted tip of the pivot section of the shaft.

With this design, dust, foreign materials, moisture or the like can be prevented from intruding into the bearing of the roller by the dust cap and the dust washer of the roller, so that the mechanism is able to keep smooth operation. The hollowed shaft can minimize the fabrication costs. Moreover, providing the collar and the ferrule for the shaft makes the mechanism of the present invention universally applicable.

Other features and advantages of the present invention will be fully understood and appreciated from the following detailed description of the preferred embodiment with reference to the accompanied drawings.

### BRIEF DESCRIPTION OF THE DRAWINGS

FIG. 1 is an exploded view of the present invention.

FIG. 1A is a perspective view of the roller viewed from the rear side according to the present invention.

FIG. 2 is a schematic view showing assembled structure of the roller and the shaft according to the present invention.

FIGS. 3A, B are illustrative views showing an application of the mechanism of the present invention to operate a garage door.

### DETAILED DESCRIPTION OF THE PREFERRED EMBODIMENT

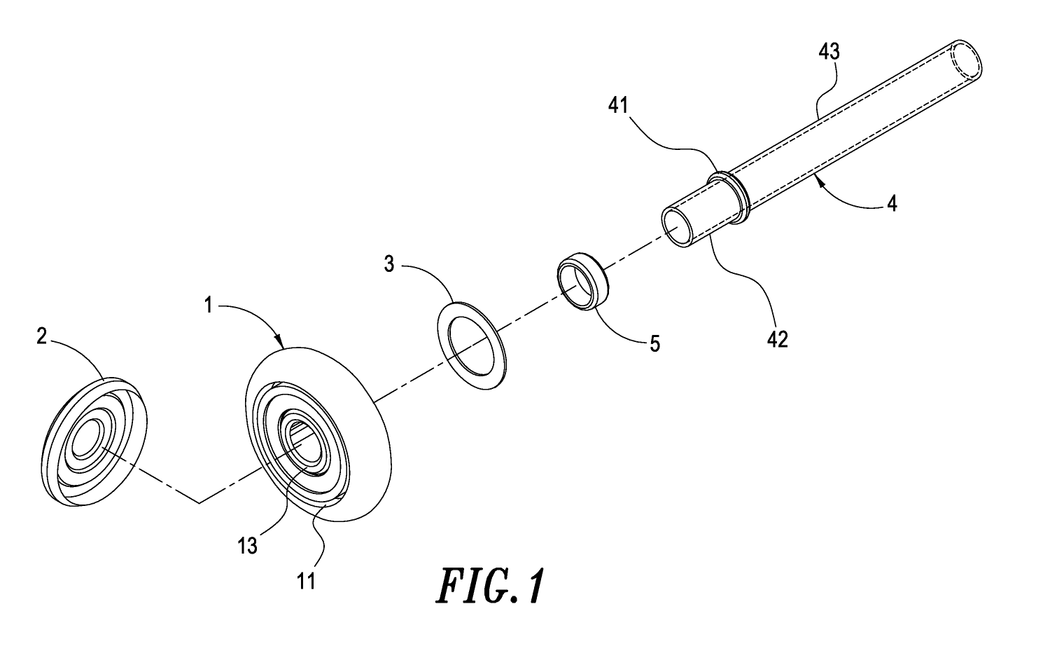

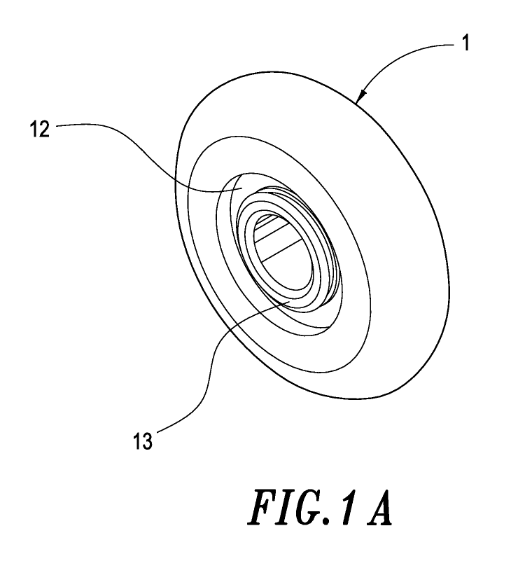

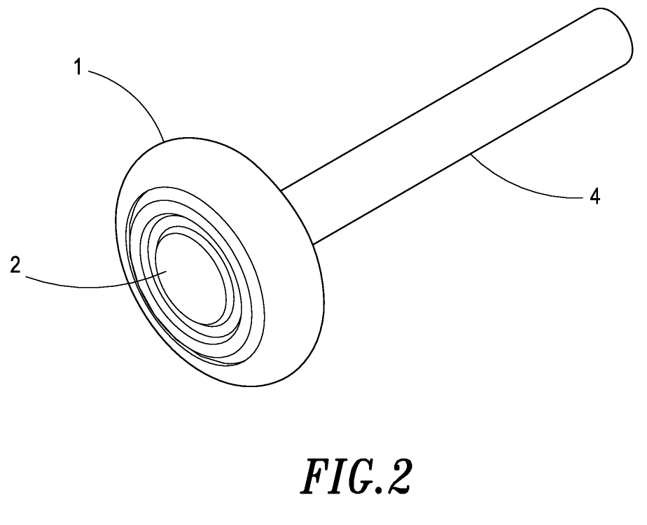

Referring to FIGS. 1 and 2, the combined mechanism of roller and shaft according to the present invention is essentially a combination of a roller 1 and a shaft 4.

Referring to the FIG. 1 and 1A, The roller 1 has a dust cap 2 covered on an annular detent groove 11 formed around the front surface of the roller 1, and a dust washer 3 to seal an annular slot 12 formed around the rear surface of the roller 1. A bearing 13 is provided at the center portion of the roller 1.

Referring to the FIG. 1, the shaft 4, which is a hollow tubular body, is ringed with a collar 41 at a proper position near its front end dividing the shaft 4 into a front pivot section 42 and a rear axle section 43. A ferrule 5, which being adapted to the pivot section 42, is detained by the collar 41. The ferrule 5 can be formed into a variety of sizes to meet a wide requirement. The ferrule 5 can be made of plastic or metallic materials.

The shaft 4 is supported by the bearing 13 of the roller 1 at the front pivot section 42 of the shaft 4 such that the roller 1 is held by the ferrule 5. Finally the roller 1 is hinged to the riveted tip of the pivot section 42 of the shaft 4 so as to complete the assembly of the combined mechanism of roller and shaft with dust and moisture free structure. The shaft 4 may be directly molded in one piece into a hollow tube, or formed into an elongated flat plate with a flange, and then coiled up to become a tubular structure by rolling mill process.

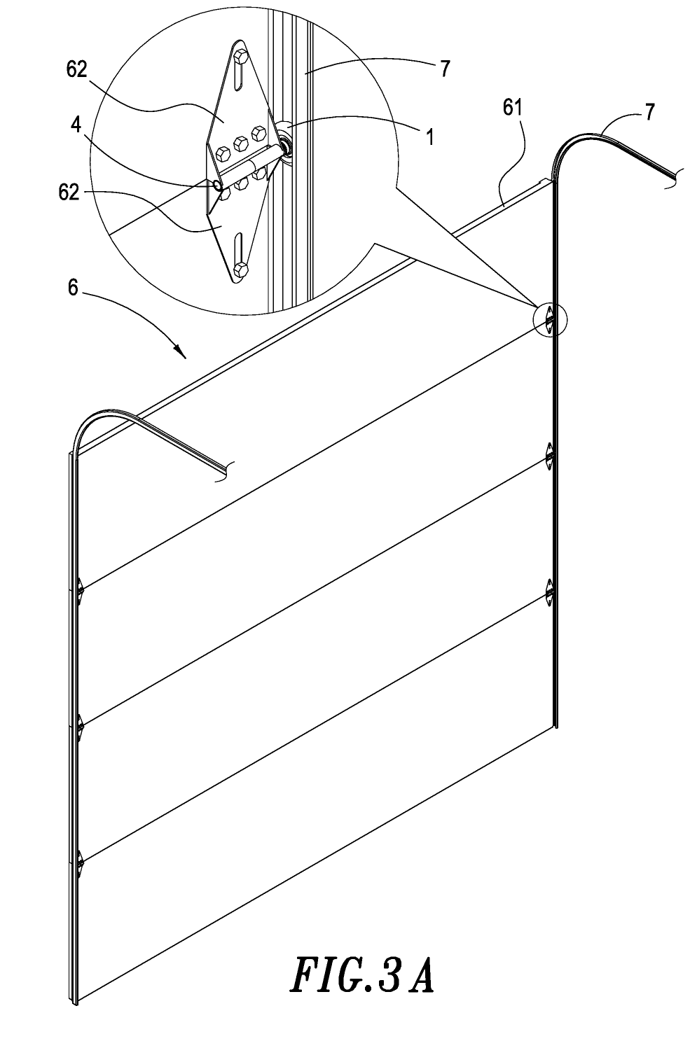

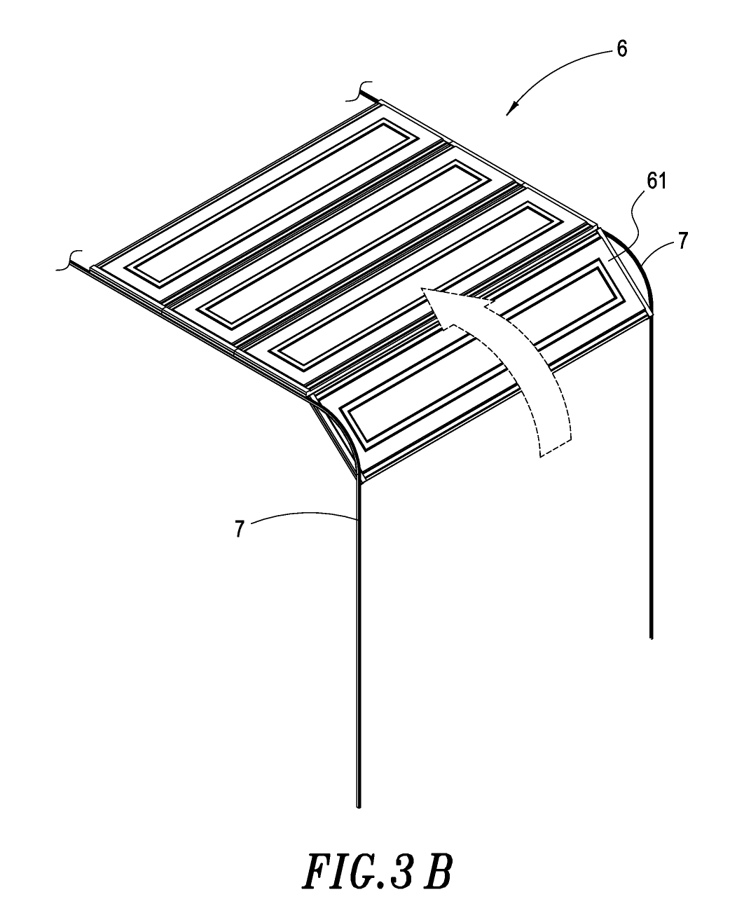

Referring to FIGS. 3A and 3B, wherein the mechanism of the present invention is applied to operate a garage door, it can be applied to lift up any vehicle's door or the belt conveyer in a workshop or the like as well.

In this embodiment, take a garage lift up door 6 for example, the door 6 is formed of several straps of door panels 61 connected one after another, and a vertical slide rail 7 is stretched from the ground up into the ceiling along each door pillar at both sides of the garage door 6. A hinged casing 62 is installed at both sides of each door panel 61 to support the shaft 4 there between and the front end of the shaft 4 is fixed to the hinged casing 62, whereas the roller 1 is accommodated in the slide rail 7. When the door 6 is to be opened, each door panel 61 is pulled backwards by applied force which actuates the roller 1 to roll up with the door panel 61 along the slide rail 7 until all the door panels 61 are lifted to the ceiling.

From the description of the above example, the invention has several noteworthy advantages, in particular:

1. The dust cap and dust washer provided for the roller contribute to keeping the roller clean and working smoothly for prolonged lifespan.

2. The hollow structure of the shaft leads to save material and therefore minimize fabrication costs.

3. Providing various sizes of ferrules accommodates various specifications of shafts required by different manufacturers.

4. The mechanism of the present invention is simple in structure, easily operable and fabricative with low cost.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A combined mechanism of roller and shaft, comprising:
a roller with a bearing provided at the center thereof;
a shaft of hollow tubular structure ringed with a collar at a proper position near the front end thereof dividing said shaft into a front pivot section and a rear axle section, wherein an ferrule, which, being adapted to said pivot section, is detained by said collar; wherein
said shaft is supported by said bearing of the roller at said front pivot section of the shaft such that said roller is held by said ferrule, and said roller is hinged to the riveted tip of said pivot section of said shaft.

2. The combined mechanism of claim 1, wherein said ferrule is made of plastic.

3. The combined mechanism of claim 1, wherein said ferrule is made of metal.

4. The combined mechanism of claim 1, wherein said shaft is made in one piece into a hollow tube by a mold.

5. The combined mechanism of claim 1, wherein said shaft is coiled into a tubular structure after being formed into an elongated flat plate.

6. A combined mechanism of roller and shaft, comprising:
a roller with a dust cap at the front side thereof, and provided with a dust washer at the rear side thereof, a bearing being provided at the center thereof;
a shaft of hollow tubular structure ringed with a collar at a proper position near the front end thereof dividing said shaft into a front pivot section and a rear axle section, wherein a ferrule, which is adapted to said pivot section, is detained by said color; wherein,
said shaft is supported by said bearing of the roller at said front pivot section of the shaft such that said roller is held by said ferrule, and said roller is hinged to the riveted tip of said pivot section said shaft.

7. The combined mechanism of claim 6, wherein said roller has an annular detent groove formed around the rear surface thereof for inserting said dust cap to seal the rear surface of said roller.

8. The combined mechanism of claim 6, wherein said roller has an annular slot formed around the rear surface thereof for inserting said dust washer to seal the rear surface of said roller.

9. The combined mechanism of claim 6, wherein said ferrule is made of plastic.

10. The combined mechanism of claim 6, wherein said ferrule is made of metal.

11. The combined mechanism of claim 6 wherein said shaft is made in one piece into a hollow tube by a mold.

12. The combined mechanism of claim 6, wherein said shaft is coiled into a tubular structure after being formed into an elongated flat plate.
